(19) United States
(12) Patent Application Publication
(10) Pub. No.: US 2021/0197827 A1
(43) Pub. Date: Jul. 1, 2021

(54) METHOD FOR COORDINATING A VEHICLE GROUP, EVALUATION UNIT, VEHICLE AND VEHICLE GROUP

(71) Applicant: ZF CV Systems Hannover GmbH, Hannover (DE)

(72) Inventor: Mathias Baum, Hannover (DE)

(21) Appl. No.: 17/199,466

(22) Filed: Mar. 12, 2021

Related U.S. Application Data
(63) Continuation of application No. PCT/EP2019/072420, filed on Aug. 22, 2019.

(30) Foreign Application Priority Data
Sep. 18, 2018 (DE) 10 2018 122 825.2

(51) Int. Cl. B60W 30/18; B60W 30/16; G08G 1/00; B60W 50/00; B60W 30/14

(52) U.S. Cl. CPC B60W 30/18163; B60W 30/16; G08G 1/22; B60W 50/0097; B60W 2552/05; B60W 2554/802; B60W 2556/45; B60W 2556/65; B60W 2554/4045; B60W 30/143

(57) ABSTRACT

A method for coordinating a vehicle group having a number of vehicles, the vehicles moving with specified setpoint distances to one another on a traffic lane and communicating wirelessly with one another via V2X communication, the specified setpoint distance being set by the respective vehicle by an adaptive cruise control system, the setpoint distances being defined such that the vehicle group is at least temporarily divided into a number of at least two partial vehicle groups, an ingress distance being at least temporarily set between the partial vehicle groups such that, between the respective partial vehicle groups, an intermediate space forms into which at least one vehicle which is ready to cut in and which has a vehicle length can move, and a group following distance which is smaller than the ingress distance being set between the vehicles within a partial vehicle group, includes: checking an ingress criterion.

### CROSS-REFERENCE TO PRIOR APPLICATIONS

This application is a continuation of International Patent Application No. PCT/EP2019/072420, filed on Aug. 22, 2019, which claims priority to German Patent Application No. DE 10 2018 122 825.2, filed on Sep. 18, 2018. The entire disclosure of both applications is incorporated by reference herein.

### FIELD

The invention relates to a method for coordinating a vehicle group composed of several vehicles, in particular utility vehicles, to an evaluation unit for carrying out the method, and to a vehicle, in particular lead vehicle, and to a vehicle group having such a vehicle or lead vehicle.

### BACKGROUND

It is known that several vehicles can move in an intercoordinated manner one behind the other on a traffic lane with short group following distances in order to save fuel owing to a reduced air resistance. Vehicles coordinated in this way are also referred to as a vehicle group, vehicle combination, vehicle train, vehicle convoy or platoon. During such coordinated driving, the safety distance between the individual vehicles that is nowadays customary can be undershot if the vehicles coordinate with one another, for example via wireless V2X communication. The individual vehicles of the vehicle group are coordinated here for example by a lead vehicle, which can communicate with the other vehicles via the wireless V2X communication and exchange data, in particular driving dynamics characteristics of the respective vehicles. Furthermore, information regarding the surroundings, including the surrounding road users, can also be exchanged. The lead vehicle can in particular specify a setpoint distance which is then set by the individual vehicles of the vehicle group by means of an adaptive cruise control system. This can ensure that the individual vehicles in the vehicle group can react more quickly to one another, whereby an impairment of safety can be avoided and thus the undershooting of the safety distance can be justified, because the reaction times are shortened.

If such a vehicle group is traveling for example on a multi-lane road, for example a highway/motorway, the vehicle group, owing to the intercoordinated setting of the driving dynamics in order to maintain the specified setpoint distance, constitutes a very long obstruction for the vehicles that wish to pass across the traffic lane of the vehicle group. This obstruction, which extends in the direction of travel of the vehicle group of several vehicles, can be overcome in the transverse direction only with difficulty by a vehicle that is situated for example on the adjacent traffic lane. This may be necessary for example if the vehicle on the adjacent traffic lane wishes to move from the motorway onto an exit ramp and, for this purpose, has to change lanes across the traffic lane occupied by the vehicle group. The respective vehicle must therefore either brake heavily in order to be able to change lanes behind the last vehicle of the vehicle group, or accelerate so intensely that it can change lanes to the exit ramp in front of the first vehicle of the vehicle group. Such braking or acceleration of the vehicle in order to move to the end or the beginning of the vehicle group is however not possible in every traffic situation and also harbors certain dangers for the following traffic as well as for the respective vehicle itself.

The same disadvantage arises for a vehicle which is situated on an entry ramp of the motorway and which moves onto the traffic lane of the vehicle group at the point in time at which the vehicle group is also situated at this point. The entering vehicle also has an opportunity to enter the motorway only if it accelerates such that it reaches the traffic lane of the vehicle group in front of the first vehicle of the vehicle group or else brakes such that it reaches this traffic lane behind the last vehicle of the vehicle group. Under certain circumstances, this can lead to the entering vehicle braking to a standstill, which has the disadvantageous consequence that it has to accelerate from a standstill in order to enter the motorway. Both possibilities for entering the motorway are therefore unsafe for the entering vehicle and also for the surrounding traffic.

To make allowance for this circumstance, it may be provided that the vehicle group is automatically broken up at entry ramps and exit ramps of the motorway in a manner controlled and/or coordinated by the lead vehicle of the vehicle group, for example the first vehicle of the vehicle group, such that the conventional safety distances between the vehicles are set again. Each vehicle then moves in an uncoordinated manner under the control of its respective driver. The driver can then, on the basis of their observations, brake their vehicle accordingly in order to enable the entering or exiting vehicle to change lanes. Furthermore, it may be provided that the driver of any vehicle of the vehicle group manually initiates a braking operation if they identify an entering or exiting vehicle. As a result, the vehicle group can be opened manually at any point in order to enable the entering or exiting vehicle to change lanes.

A disadvantage of these stated methods is that the vehicle group is at least temporarily not coordinated, and as a result the advantages of a vehicle group or platoon can no longer be ensured. In addition, following such a traffic situation that causes the vehicle group to break up, the vehicle group must again be correspondingly set up and coordinated with one another, which results in increased feedback control outlay.

Another solution provides that the number of vehicles in a vehicle group is limited, for example to three vehicles. The length of the obstruction is thus limited, such that, with an anticipatory driving style, entry or exit is readily possible.

Furthermore, it can be provided that, when an entry ramp or an exit ramp is identified, the vehicle group is temporarily divided into several partial vehicle groups (sub-platoons) in this region, regardless of whether a vehicle wishes to enter or exit. Here, a certain number of vehicles moves within each partial vehicle group, between which vehicles the group following distance is specified as the setpoint distance. An ingress distance is specified as the setpoint distance between the individual partial vehicle groups, which ingress distance allows entering and exiting vehicles to move onto the traffic lane of the vehicle group in the region of the entry ramp or the exit ramp. After the entry ramp or the exit ramp has been passed, the partial vehicle groups are automatically merged again. A disadvantage here is that individual vehicles of the vehicle group change their driving dynamics in the region of entry ramps and exit ramps even if no vehicle wishes to enter or exit. The partial vehicle groups then have to be merged again. Overall, unnecessary feedback control of the setpoint distances is thus carried out under certain circumstances, resulting in unnecessary braking and driving operations for some of the vehicles.

The automated setting of a setpoint distance following identification of a vehicle in the traffic lane of the vehicle group is known for example from DE 11 2014 004 023 T5. According to said document, coordinated driving still takes place if an unknown vehicle has already cut in between the vehicles of the vehicle group into its traffic lane. The vehicle group is accordingly subsequently divided into two partial vehicle groups owing to the unknown vehicle, wherein these continue to move in a coordinated manner with respect to one another. After the unknown vehicle has ingressed, an ingress distance can be set between the two partial vehicle groups, which ingress distance is greater than the conventional setpoint distance or group following distance between the individual vehicles. In this way, coordinated driving operation continues to be ensured, and it is at the same time ensured that the unknown vehicle does not obstruct the vehicles of the vehicle group or of the partial vehicle groups. A disadvantage here is that a reaction with an increase in distance is performed only when the unknown vehicle has already cut in. A division into several partial vehicle groups, and accordingly a reaction to the vehicle that has cut in, accordingly takes place only after the time at which the cutting-in occurs.

According to U.S. Pat. No. 9,396,661 B2, it is provided that a vehicle group can be divided into several vehicle groups if a vehicle moving in the vicinity requests, by means of a request signal, that said vehicle wishes to join the vehicle group. In a coordinated manner, an ingress distance is then set between two defined vehicles of the vehicle group, which ingress distance enables the vehicle which is ready to cut in to ingress into the vehicle group. Accordingly, in this case, too, the vehicle group is divided into two partial vehicle groups, wherein this occurs in response to an active request from the respective vehicle via wireless V2X communication. If a vehicle which is ready to cut in does not have such a means of communication, it can move onto the traffic lane of the vehicle group only in front of or behind the vehicle group, whereby entry into or exit from a motorway is made more difficult. A similar procedure is described in U.S. Pat. No. 9,799,224 B2.

In US 2016/0019782 A1, it is furthermore described that warning indications or warning information can be displayed to vehicles situated in the vicinity of the vehicle group, which warning indications or warning information cannot be perceived by the driver of the respective vehicle themself, for example owing to the extent of the vehicle group or of the individual vehicles.

### SUMMARY

In an embodiment, the present invention provides a method for coordinating a vehicle group comprising a number of vehicles, the vehicles of the vehicle group moving with specified setpoint distances to one another on a traffic lane and communicating wirelessly with one another via V2X communication, the specified setpoint distance being set by the respective vehicle by an adaptive cruise control system, the setpoint distances being defined such that the vehicle group is at least temporarily divided into a number of at least two partial vehicle groups, an ingress distance being at least temporarily set between the partial vehicle groups such that, between the respective partial vehicle groups, an intermediate space forms into which at least one vehicle which is ready to cut in and which has a vehicle length can move, and a group following distance which is smaller than the ingress distance being set between the vehicles within a partial vehicle group, the method comprising: checking an ingress criterion in a manner dependent on surroundings data, the ingress criterion indicating whether, in surroundings around the vehicle group, there is situated at least one vehicle which is ready to cut in and which intends to move into a traffic lane of the vehicle group in the region of the vehicle group, wherein, if the ingress criterion is fulfilled, the vehicle group is divided into at least two partial vehicle groups by the ingress distance being specified as the setpoint distance for at least one vehicle of the vehicle group, which is preceded by a vehicle of the same vehicle group, to form the intermediate space.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a vehicle group composed of several vehicles on a multi-lane road;

FIGS. 2a, 2b show the vehicle group as per FIG. 1 in an entry situation and in an exit situation respectively;

FIG. 3 shows a flow diagram of the method according to the invention.

### DETAILED DESCRIPTION

In an embodiment, the present invention provides a method for coordinating vehicles of a vehicle group with which safe driving operation of the vehicles surrounding the vehicle group can be ensured. In an embodiment, the present invention provide an evaluation unit, a vehicle and a vehicle group.

According to the invention, it is therefore provided that, for coordinating a vehicle group composed of a number of vehicles, wherein the vehicles of the vehicle group move with specified setpoint distances to one another on a traffic lane and the vehicles communicate wirelessly with one another via V2X communication, wherein the specified setpoint distance is set by the respective vehicle by means of an adaptive cruise control system, the setpoint distances between these vehicles are specified such that the vehicle group is at least temporarily divided into a number of at least two partial vehicle groups, wherein, for this purpose, an ingress criterion is checked in a manner dependent on surroundings data, wherein the ingress criterion indicates whether, in surroundings around the vehicle group, there is situated at least one vehicle which is ready to cut in and which intends to move into a traffic lane of the vehicle group in the region of the vehicle group. If the ingress criterion is fulfilled, the vehicle group is at least temporarily divided into at least two partial vehicle groups by virtue of an ingress distance being specified as the setpoint distance for at least one vehicle of the vehicle group, which is preceded by a vehicle of the same vehicle group, for the purposes of forming an intermediate space into which the at least one vehicle which is ready to cut in and which has a particular vehicle length can move.

In this way, an intermediate space forms between the respective partial vehicle groups advantageously only if, from the surroundings data, a vehicle is detected that wishes to cut into the traffic lane of the vehicle group. Between all other vehicles within a partial vehicle group, a group following distance is set which is smaller than the ingress distance, in order to allow intercoordinated, efficient driving within the vehicle group. The group following distance may be less than 25 meters, in particular less than 15 meters. The definition of the group following distance is performed preferably in a manner dependent on driving dynamics characteristics of the vehicles of the vehicle group, which are transmitted between the individual vehicles via the V2X communication for the purposes of defining the group following distance in an intercoordinated manner.

The group following distance is furthermore set between all vehicles if the ingress criterion is not fulfilled and after it has been detected that the vehicle which is ready to cut in has moved away again from the intermediate space, which corresponds to the normal driving operation of the vehicle group. Accordingly, the vehicles of the vehicle group are, in the respective situations, operated in the usual way with setpoint distances that are smaller than the conventional safety distances, such that utilization of the slipstream is made possible with short reaction times owing to the V2X communication between the vehicles.

The vehicle group is thus opened in targeted fashion only in certain situations in which a vehicle also actually wishes to ingress or cut into the traffic lane of the vehicle group, wherein, however, coordinated driving operation is still possible even then, because the vehicle group is not broken up but can continue to communicate with one another via the V2X communication. Because the setpoint distance between the partial vehicle groups is not too great, there is an improved possibility of wireless V2X communication between these than if the partial vehicle groups were independent of one another in terms of driving dynamics and were to thus, under certain circumstances, drive with very large setpoint distances to one another.

Owing to the use of the surroundings data, which preferably characterize the surroundings around the vehicle group, the vehicle group is advantageously not dependent on V2X communication with the vehicle which is ready to cut in. Accordingly, the vehicle group can itself identify the situation and assess whether a vehicle wishes to cut in, in order to thereupon form an intermediate space. For this purpose, the surroundings data are preferably output by at least one surroundings detection system, wherein the respective surroundings detection system monitors surroundings around the vehicle group, wherein the surroundings data can be transmitted via the V2X communication between the vehicles of the vehicle group and/or between the vehicles and an infrastructure facility outside the vehicle group, which infrastructure facility has an external surroundings detection system.

Accordingly, with internal surroundings detection systems that are already present in the vehicles, and/or with recourse to surroundings detection systems in the surroundings, which for example monitor an entry ramp and/or an exit ramp, it can advantageously be identified whether a division of the vehicle group is necessary. These data can be provided in a simple manner via the V2X communication, wherein the processing of this data can then preferably take place in an evaluation unit in one of the vehicles of the vehicle group, which then specifies the setpoint distance or the ingress distance for the respective vehicle in order to divide the group.

In order to make the check more reliable, it may preferably be provided that the surroundings data from different surroundings detection systems are merged. In this way, improved depth information can be extracted or the detection region can be enlarged, because a surroundings detection system in one of the rear vehicles or outside the vehicle group in an infrastructure facility may see more or different regions of the surroundings than the surroundings detection system in the front vehicles of the vehicle group. Furthermore, it can be achieved in this way that the vehicles require fewer sensors in order to adequately detect the surroundings (in particular laterally), because the rear vehicles can also cover lateral regions of the vehicle in front using conventionally forward-facing sensors.

According to a preferred embodiment, it is provided that, as ingress criterion, it is checked whether a predicted trajectory, which results from the surroundings data, of a vehicle situated in the surroundings has a future point of convergence with the vehicle group, in order to determine whether, in the surroundings, there is situated a vehicle which is ready to cut in and which intends to move into the traffic lane of the vehicle group in the region of the vehicle group. Accordingly, it can be determined in a simple manner from the surroundings data whether the ingress criterion is fulfilled and whether it is necessary or sensible to divide the vehicle group.

In a manner dependent on this check, it may preferably be provided that the vehicle of the vehicle group for which the ingress distance is specified as the setpoint distance, in order to divide the vehicle group, is selected in a manner dependent on the point of convergence such that the vehicle which is ready to cut in and which is following the predicted trajectory can approximately maintain its cut-in speed when cutting into the intermediate space. As a result, the cutting-in maneuver is made safer, because the intermediate space is formed exactly in the region into which the vehicle would ingress while maintaining its driving dynamics.

It is preferably furthermore provided that, for the check of the ingress criterion, cut-in indications are taken into consideration, wherein the activation of a turn signal and/or of a headlamp flasher of a vehicle in the surroundings, which indicate whether the vehicle in the surroundings in the region of the vehicle group wishes to move onto the traffic lane of the vehicle group, are taken into consideration as cut-in indications. Accordingly, further indications may be taken into consideration in order to more reliably assess the possible ingress or cut-in of a vehicle. These indications may be taken into consideration either on their own or together with the trajectory, for example in order to allow a plausibility check.

According to a preferred embodiment, it may furthermore be provided that the ingress criterion is checked, and/or the ingress distance is specified as the setpoint distance for the respective vehicle, in order to form the intermediate space, if the ingress criterion is fulfilled, only if the vehicle group is approaching an entry ramp and/or an exit ramp, such that the division into at least two partial vehicle groups takes place only if the vehicle group is approaching an entry ramp and/or an exit ramp. In this way, it can advantageously be achieved that an intermediate space is formed only if it can be assumed with a high degree of probability that a vehicle wishes to cross through the vehicle group, which is normally the case at entry ramps or exit ramps. In this way, said vehicle can be prevented from cutting in and permanently remaining in the intermediate space. The presence of an entry ramp and/or of an exit ramp may also preferably result from the surroundings data, such that no further data are necessary.

It is particularly preferably provided that, in the context of the division of the vehicle group into at least two partial vehicle groups by specification and setting of the ingress distance as the setpoint distance in the vehicle, no communication is performed via the V2X communication with a vehicle which is ready to cut in. Accordingly, it is possible to react to vehicles in the surroundings even if they do not have V2X communication, because the check of the ingress criterion is performed exclusively on the basis of the surroundings data.

It is preferably provided that, if the ingress criterion is fulfilled, a vehicle of the vehicle group is selected as guide vehicle of a following partial vehicle group, wherein the ingress distance is specified as the setpoint distance for this selected guide vehicle of the respective following partial vehicle group, such that a guide partial vehicle group is followed, at the ingress distance, by at least one following partial vehicle group led by the selected guide vehicle.

Here, according to one embodiment, the specified of the ingress distance is defined such that, after setting of the ingress distance as the setpoint distance, an intermediate space forms between the partial vehicle groups thus formed, such that a vehicle which is ready to cut in and which has a vehicle length not exceeding a predefined maximum length can move onto the traffic lane of the vehicle group into the intermediate space between the at least two partial vehicle groups. Here, the maximum length may be between 5 m and 10 m, preferably 6 m. Thus, with little outlay in terms of closed-loop control and evaluation, an ingress spacing is defined which encompasses a major proportion of the vehicles, in particular passenger motor vehicles, for which the vehicle group can constitute an obstruction, and which conventionally cannot communicate with the vehicle group and accordingly cannot make themselves known via wireless V2X communication either. In this way, for these types of vehicles, an ingress distance is defined which does not necessarily require an exact detection of the length.

According to an alternative embodiment, however, it may also be provided that the ingress distance is defined in a manner dependent on the vehicle length of the vehicle which is ready to cut in, wherein the vehicle length is derived from the surroundings data. A targeted division of the vehicle group is thus possible.

Thus, the intermediate space is defined only in a manner dependent on geometrical dimensions of a vehicle that is potentially ready to cut in, in order to give this the opportunity to pass or cross the traffic lane of the vehicle group, that is to say if the vehicle group constitutes an obstruction owing to its length, in particular at entry ramps or exit ramps. The ingress distance should in any case be smaller than the conventional safety distance such that the vehicle group is also perceived from the outside as a divided vehicle group and not as two independent vehicle groups and vehicles do not constantly cut in between the partial vehicle groups.

According to a preferred embodiment, it is provided for this purpose that the ingress distance is defined additionally in a manner dependent on a minimum distance which is maintained in front of and behind the vehicle which is ready to cut in and which has the vehicle length or the maximum length, wherein the minimum distance lies between 10 m and 25 m. The application of the minimum distance takes into consideration a form of reduced safety distance. This ensures that the driver of the vehicle which is ready to cut in recognizes that they have been given an opportunity to drive through the obstruction with a high degree of safety. If the ingress distance is too short, the driver of a vehicle which is ready to cut in may otherwise react anxiously, as he considers ingressing into a very long vehicle group, composed for example of utility vehicles, to involve a high risk. In addition, the minimum distance can avoid the risk of rear-end collisions while the vehicle is situated between the partial vehicle groups. Specifically, unlike the vehicles of the vehicle group, the vehicle that has cut in does not coordinate with the other vehicles. However, the vehicle that has cut in does not normally remain in the intermediate space for very long. If it does, it may be provided that the ingress distance is correspondingly adapted and/or the vehicle that has cut in is given an indication that it should exit the traffic lane of the vehicle group.

According to a preferred refinement, it is provided that the ingress distance is defined under the condition that, after setting of the ingress distance, vehicles of different partial vehicle groups can continue to indirectly or directly communicate wirelessly with one another via the V2X communication for the purposes of continuously coordinating the vehicle group as a whole. This advantageously achieves that the vehicle group as a whole can always also be operated in a coordinated manner, in order to react to the present driving situation, despite the intermediate space formed.

It may preferably also be provided that the ingress distance is defined in a manner dependent on whether two or more vehicles which are ready to cut in are identified in the surroundings. Advantageously, it is thus also possible for more than one vehicle to be given space to cross if this is considered efficient and sensible, for example if two vehicles wish to enter directly one behind the other and the vehicle group thus does not have to be opened to too great an extent.

Preferably, in the context of the invention, a vehicle which is ready to cut in is to be understood to mean an entering vehicle, which intends to move from an entry ramp onto the traffic lane of the vehicle group, or is a vehicle which is ready to exit, which intends to move from an adjacent traffic lane via the traffic lane of the vehicle group onto an exit ramp. In principle, however, other cutting-in maneuvers are also possible in order to avoid safety-critical situations.

According to the invention, an evaluation unit is furthermore provided by means of which the described method can be carried out, wherein the evaluation unit is designed to define the setpoint distances between vehicles of a vehicle group such that the vehicle group at least is temporarily divided into a number of at least two partial vehicle groups, wherein, for this purpose, the evaluation unit can at least temporarily set an ingress distance between the partial vehicle groups such that, between the respective partial vehicle groups, an intermediate space forms into which at least one vehicle which is ready to cut in and which has a vehicle length can move, and can set a group following distance, which is smaller than the ingress distance, between the vehicles within a partial vehicle group. According to the invention, it is provided here that the evaluation unit can furthermore check an ingress criterion in a manner dependent on surroundings data, wherein the ingress criterion indicates whether, in surroundings around the vehicle group, there is situated at least one vehicle which is ready to cut in and which intends to move into a traffic lane of the vehicle group in the region of the vehicle group, wherein, if the ingress criterion is fulfilled, the vehicle group can be divided into at least two partial vehicle groups by virtue of the ingress distance being specifiable as the setpoint distance for at least one vehicle of the vehicle group, which is preceded by a vehicle of the same vehicle group, for the purposes of forming the intermediate space.

According to the invention, a vehicle which functions in particular as a guide vehicle in a vehicle group is also provided, which has an evaluation unit of said type. Furthermore, a vehicle group composed of several vehicles is provided, wherein at least one of the vehicles, as lead vehicle, has an evaluation unit of said type, and the lead vehicle can communicate wirelessly with the vehicles of the vehicle group via V2X communication, wherein the vehicles each have an adaptive cruise control system, wherein the adaptive cruise control system is in each case designed to set the setpoint distance, which is specified by the lead vehicle by means of the evaluation unit and which is transmitted via the V2X communication, to the respectively proceeding vehicle of the vehicle group for the purposes of at least temporarily dividing the vehicle group into at least two partial vehicle groups.

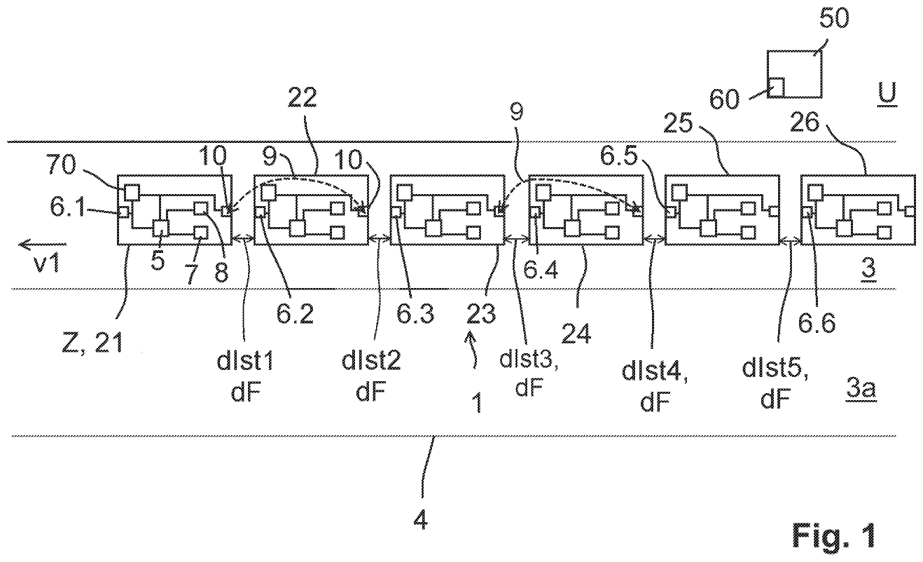

According to FIG. 1, a vehicle group 1 composed of a number N of six vehicles 2i, where i=1, 2, . . . N, is illustrated, which are moving with a particular actual distance dlstj, where j=1, 2, . . . N−1, to one another on a traffic lane 3 of a multi-lane road 4, for example of a highway. Here, in the context of the invention, a vehicle group 1 is to be understood to mean a series of vehicles 2i that are moving in an intercoordinated manner in order to ensure the most economical driving operation possible through utilization of the slipstream and avoidance of unnecessary acceleration and deceleration phases. Such a vehicle group 1 is also known to the person skilled in the art as a vehicle combination, vehicle convoy, vehicle train, vehicle column or platoon.

The vehicle group 1 as a whole is coordinated by a lead vehicle Z, which in FIG. 1 is simultaneously the first vehicle 21 of the vehicle group 1. In principle, however, it is also possible for one of the other vehicles 2i to be the lead vehicle Z. To coordinate the vehicle group 1, the lead vehicle Z defines, on the basis of predetermined parameters, the setpoint distance dSollj, where j=1, 2, . . . N−1, with which the individual vehicles 2i of the vehicle group 1 should move relative to one another.

The setpoint spacing dSollj between the individual vehicles 2i may be defined for example in a manner dependent on vehicle-specific characteristics of the respective vehicle 2i, for example a braking capability, a vehicle status, etc., as well as implemented with the stipulation that particularly efficient driving operation is made possible in the vehicle group 1 as a whole, utilizing the slipstream. A so-called group following distance dF defined in this way as setpoint distance dSollj between the respective vehicles 2i may be smaller than the conventional safety distance between two vehicles, because the vehicles 2i move in an intercoordinated manner and communicate with one another, whereby safe driving operation can even then still be ensured.

In order to be able to set the respectively defined setpoint distance dSollj between the individual vehicles 2i, each of the vehicles 2i has an adaptive cruise control system 5, wherein, by means thereof, in the manner of an intelligent cruise control system, the in each case i-th vehicle 2i detects the actual distance dIstj (where j=i−1) to the respectively preceding (i−1)-th vehicle 2(i−1) by means of an internal surroundings detection system 6i in the subject vehicle 2i, and, through an intervention in the braking system 7 and/or the drive system 8 of the subject vehicle 2i, adjusts the detected actual distance dIstj to the setpoint distance dSollj (where j=i−1), specified by the lead vehicle Z, to the preceding (i−1)-th vehicle 2(i−1).

The transmission of the defined setpoint distance dSollj from the lead vehicle Z to the respective vehicles 2i of the vehicle group 1 takes place via wireless V2X communication 9, which is established between the individual vehicles 2i. For this purpose, in each of the vehicles 2i, there is arranged a V2X unit 10 which, in a conventional manner, has a transmitting and receiving module by means of which, in particular, the setpoint distance dSollj can be transmitted and received, such that this can be set by means of the adaptive cruise control system 5 in the respective vehicle 2i. For this purpose, the adaptive cruise control system 5 is connected to the V2X unit 10 in any signal-conducting manner.

V2X (Vehicle-to-Everything) is a wireless communication facility that allows the individual vehicles 2i to provide signals via a specific interface or in accordance with a specific protocol in order to coordinate with one another. If such communication takes place only between the vehicles 2i, it is referred to as V2V (Vehicle-to-Vehicle). However, communication between a vehicle 2i and an infrastructure facility 50 at the edge of the traffic lane 3 is also possible, which is then referred to as V2I (Vehicle-to-Infrastructure).

For example, a short-range DSRC connection (Dedicated Short-Range Communication) or a wireless connection according to one of the IEEE standards, for example IEEE 802.11 (Wireless Access in Vehicular Environments (WAVE)) or IEEE 802.11p (see IEEE 802.11 Wireless LAN medium access layer (MAC)), may be used as the form of transmission. The V2X unit 10 may for example allow signal transmission via WiFi, WLAN, Ultra Mobile Broadband (UMB), Bluetooth (BT), Near Field Communication (NFC), Radio Frequency Identification (RFID), Z-wave, ZigBee, Low power Wireless Personal Area Networks (6LoWPAN), Wireless Highway Addressable Remote Transducer (HART) Protocol, Wireless Universal Serial Bus (USB) or via optical communication facilities, for example Infrared Data Association (IrDA). Alternatively, transmissions are however also possible by means of the (mobile radio) standards 3GPP LTE, LTE-Advanced, E-UTRAN, UMTS, GSM, GSM/EDGE, WCDMA, Time Division Multiple Access (TDMA), Frequency Division Multiple Access (FDMA), Orthogonal FDMA (OFDMA), Single-Carrier FDMA (SC-FDMA), Worldwide Interoperability for Microwave Access (WiMax), Ultra Mobile Broadband (UMB), High Speed Packet Access (HSPA), Evolved Universal Terrestrial Radio Access (E-UTRA), Universal Terrestrial Radio Access (UTRA), GSM EDGE Radio Access Network (GERAN), etc.

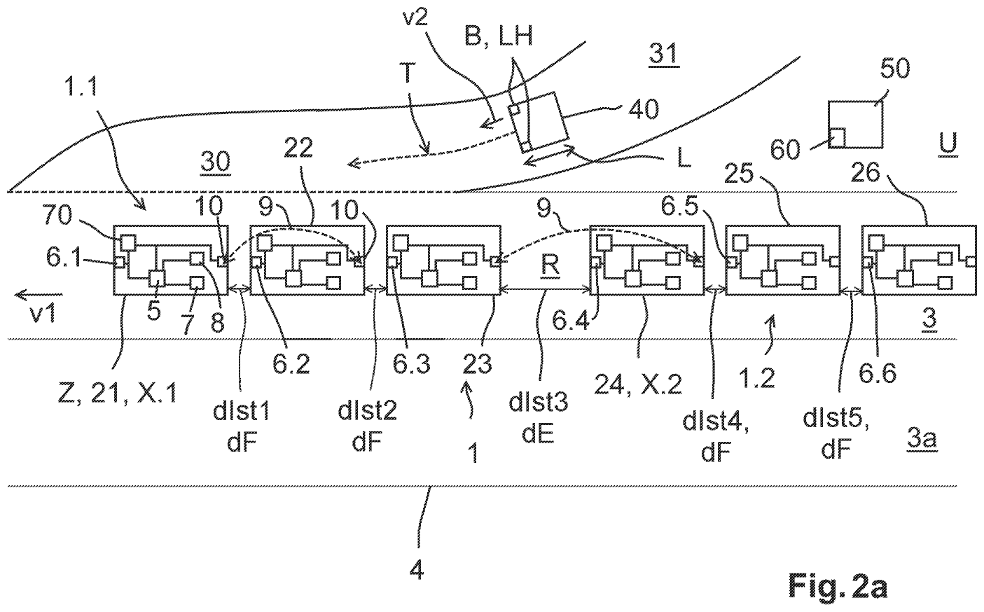

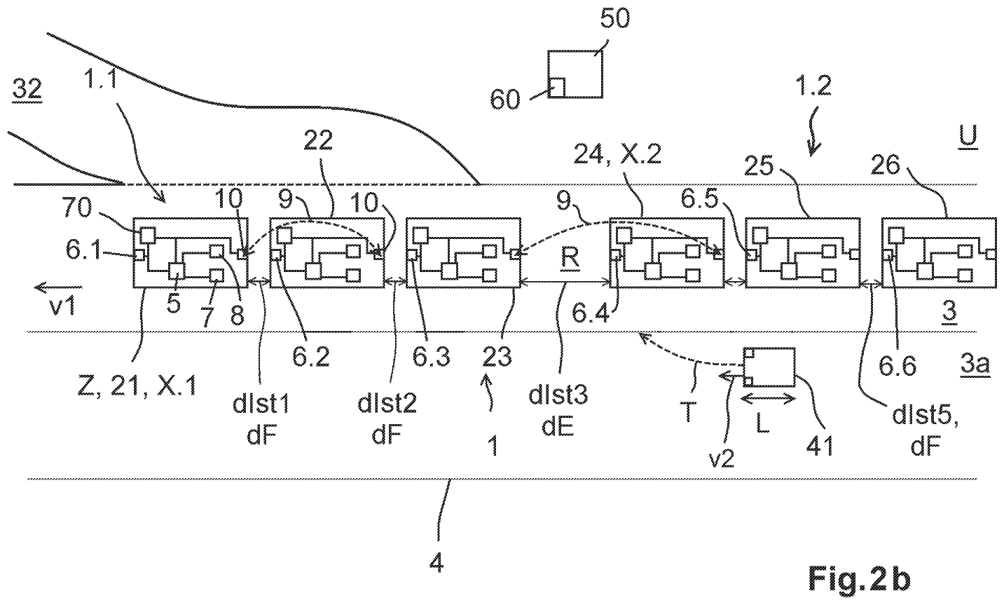

After setting of the respective setpoint distances dSollj, the thus set-up vehicle group 1 moves at a certain group speed v1 on the traffic lane 3. If such a vehicle group 1 moves, as per FIG. 2a, toward an entry ramp region 30 of the multi-lane road 4, via which an entering vehicle 40 can move from an entry ramp 31 onto the multi-lane road 4, the vehicle group 1 may constitute an obstruction for this entering vehicle 40. This is the case specifically when the entering vehicle 40 in the entry ramp region 30 is ready to enter the traffic lane 3 while the vehicle group 1 is presently passing the entry ramp region 30.

In order to counteract this, the entering vehicle 40 can, in an anticipatory manner, drive along the entry ramp 31 such that it moves onto the traffic lane 3 in front of or behind the vehicle group 1. In the case of a very long vehicle group 1, however, this may constitute a safety risk, because the entering vehicle 40 has to accelerate too intensely or drive on the hard shoulder in order to cut in in front of the vehicle group 1, or has to brake heavily, and under certain circumstances almost to a standstill, in order to cut in behind the vehicle group 1.

Another possibility is to cut in between the vehicles 2i of the vehicle group 1. The group following distance dF between the vehicles 2i is however normally so small, for example 15 m, that, in the case of a high group speed v1 of approximately 70-90 km/h, it is very difficult for an entering vehicle 40 to cut in without taking increased safety risks.

A similar critical situation emerges from FIG. 2b, in which a vehicle 41 which is ready to exit is situated on the adjacent traffic lane 3a in relation to the vehicle group 1. Said vehicle intends to take the next exit ramp 32 from the multi-lane road 4, wherein, in this case, too, the vehicle group 1 may again constitute an obstruction. The vehicle 41 which is ready to exit may accordingly attempt, by accelerating or decelerating, to move onto the traffic lane 3 of the vehicle group 1 in front of or behind the vehicle group 1 in order to subsequently move onto the exit ramp 32, though this is not always possible without impeding the other traffic. Furthermore, said vehicle may also cut in onto the traffic lane 3 between the vehicles 2i of the vehicle group 1, which however represents an increased safety risk.

According to the invention, in order to avoid these critical driving situations, the vehicle group 1 is, according to the situation, divided into a number M of at least two partial vehicle groups 1.k, k=1, 2, . . . M, wherein a guide partial vehicle group 1.1 is followed by at least one following partial vehicle group 1.k, k>1, and an intermediate space R is formed between each partial vehicle group 1.k. In the exemplary embodiment of FIGS. 2a, 2b, two partial vehicle groups 1.1, 1.2 are provided with an intermediate space R between them, wherein each partial vehicle group 1.1, 1.2 is composed of in each case three vehicles 2i. If further vehicles 2i, that is to say N>6, are provided in the vehicle group 1, it is also possible for more than two partial vehicle groups 1.k, where k=1, 2, 3, . . . , M, that is to say more than one following partial vehicle group 1.k, k>1, and/or partial vehicle groups 1.k with in each case more than three vehicles 2i, but preferably not more than in each case eight vehicles 2i, in particular not more than in each case five vehicles 2i, to be formed.

The first vehicle 21, 24 of the respective partial vehicle group 1.k will hereinafter be referred to as guide vehicle X.k of the k-th partial vehicle group 1.k, which thus leads the respective partial vehicle group 1.k. Accordingly, in FIGS. 2a, 2b, the first vehicle 21 of the vehicle group 1 is simultaneously also the guide vehicle X.1 of the first partial vehicle group 1.1 or of the guide partial vehicle group 1.1, and the fourth vehicle 24 of the vehicle group 1 is the guide vehicle X.2 of the second partial vehicle group 1.2 or of the first following partial vehicle group 1.2.

The distance, set according to the situation, between the partial vehicle groups 1.k, in FIGS. 2a, 2b the third actual distance dIst3 between the third vehicle 23 or the last vehicle of the first partial vehicle group 1.1 (guide partial vehicle group 1.1) and the fourth vehicle 24 or the guide vehicle X.2 of the second partial vehicle group 1.2 (first following partial vehicle group 1.2), will hereinafter generally be referred to as ingress distance dE, which thus indicates a length of the intermediate space R between the partial vehicle groups 1.k.

The division of the vehicle group 1 into several such partial vehicle groups 1.k according to the situation is preferably coordinated from the lead vehicle Z, wherein the lead vehicle Z, after checking ingress criteria K, defines which vehicle 2i of the vehicle group 1 is to become a guide vehicle X.k, k>1 of a following partial vehicle group 1.k, k>1. Subsequently, an ingress distance dE is specified as the setpoint distance dSollj for this defined vehicle 2i or guide vehicle X.k, k>1 of the following partial vehicle group 1.k, k>1, which ingress distance is then usually greater than the defined group following distance dF for the vehicles 2i within a partial vehicle group 1.k. The vehicle group 1 is then divided by virtue of this ingress distance dE being set by means of the adaptive cruise control system 5 of the respective guide vehicle X.k, k>1.

The inventive division of the vehicle group 1 accordingly makes it easier for the entering vehicle 40 to drive onto the multi-lane road 4 into the intermediate space R between the multiple partial vehicle groups 1.k, because the ingress distance dE is larger than the group following distance dF. Thus, depending on the number M of partial vehicle groups 1.k, the entering vehicle 40 is given at least one further opportunity to cut in which is less safety-critical than cutting in between the vehicles 2i of a partial vehicle group 1.k or in front of and behind the vehicle group 1 as a whole.

The specification of the ingress distance dE according to the situation for the purposes of dividing the vehicle group 1 is performed in a manner dependent on ingress criteria K that are to be checked. Accordingly, the vehicle group 1 reacts under given circumstances to certain events in surroundings U, preferably to possible cutting-in maneuvers by other vehicles 40, 41. In this case, however, the events are not triggered by active communication, for example a cut-in request, between the potentially cutting-in vehicle 40, 41 and the vehicles 2i of the vehicle group 1. Rather, the vehicle group 1 or the lead vehicle Z itself identifies such an event.

The checking of the ingress criteria K is performed in the lead vehicle Z on the basis of surroundings data UD, which are provided to the lead vehicle Z via the wireless V2X communication 9 or ascertained by the lead vehicle Z itself. Here, the surroundings data UD may be provided from the vehicles 2i of the vehicle group 1 itself or from an external source, for example from an infrastructure facility 50. Here, the surroundings data UD contain information or images recorded from the surroundings U, from which it can be derived whether, in the surroundings U around the vehicle group 1, there is situated a vehicle 40, 41 which is ready to cut in and which is likely to intend to move onto the traffic lane 3 of the vehicle group 1 in the region of the vehicle group 1. In addition, a vehicle length L of this vehicle 40, 41 which is ready to cut in can be estimated from the surroundings data UD.

This information can be extracted for example from the surroundings data UD, which are recorded and output by the internal surroundings detection system 6i in the respective vehicle 2i of the vehicle group 1 or else by an external surroundings detection system 60 outside of the vehicles 2i, for example at the respective infrastructure facility 50. For this purpose, the respective surroundings detection system 6i, 60 has for example a camera and/or a radar system and/or LIDAR, which can in each case detect objects in the surroundings U and output the surroundings data UD in each case in a manner dependent thereon. Conventional vehicles 2i are advantageously already equipped with an internal surroundings detection system 6i, for example in the context of the adaptive cruise control system 5, such that no retrofitting is required and it is necessary only to provide an output via the V2X communication 9 by means of the V2X unit 10, such that the lead vehicle Z can access said output.

Through the provision of the surroundings data UD via the wireless V2X communication 9, the lead vehicle Z can not only evaluate the present surroundings situation in a manner dependent on the perspective of its own surroundings detection system 61, but can also detect and evaluate the present surroundings situation from a different perspective, that is to say for example from the perspective of the rear vehicles 2i, where i>1, or else of the infrastructure facility 50 outside the traffic lane 3. A merging of surroundings data UD from different surroundings detection systems 6i, 60 may also be performed in order to increase the reliability of the check of the ingress criterion K. For example, a vehicle 2i of the vehicle group 1 which is traveling further toward the rear can provide more precise depth information regarding the surroundings U or identified vehicles 40, 41, and thus allow a more precise determination of the future traveling movement of the vehicle 40, 41, for example in the form of a predicted trajectory T, as well as of the vehicle length L, in the lead vehicle Z. In addition, a vehicle 2i of the vehicle group 1 which is situated further toward the rear can detect surroundings data UD which cannot be detected by the lead vehicle Z, for example because the detection range of the surroundings detection system 61 in the lead vehicle Z does not allow this. This means that there is no need to retrofit side-view sensors in the front vehicles 2i of the vehicle group 1, because the rear vehicles 2i can supply information regarding these regions of the surroundings U.

Here, the evaluation and assessment of the surroundings data UD is performed in an evaluation unit 70 in the lead vehicle Z, in which the ingress criterion K is checked for each identified, preferably moving object in the surroundings U. Here, the assessment of a moving object is performed for example by means of an object detection algorithm which identifies object contours from the output surroundings data UD and tracks these, preferably with depth resolution, over the course of time. From this, a trajectory T for the respective identified object or vehicle 40, 41 can be predicted, and from this, it can be predicted whether the vehicle 40, 41 intends to cut into the traffic lane 3 of the vehicle group 1.

The ingress criterion K can be fulfilled for the respective object if it is determined on the basis of the predicted trajectory T that the vehicle 40, 41 identified as being ready to cut in arrives in the traffic lane 3 of the vehicle group 1 in the region of the vehicle group 1. At the same time, it may be taken into consideration here whether the vehicle 40, 41 which is ready to cut in could cut in in front of or behind the vehicle group 1 in a non-safety-critical manner, for example by means of a slight change in its driving dynamics, that is to say a slight acceleration or deceleration.

Owing to the fulfilled ingress criterion K, the vehicle group 1 is divided in order to offer the vehicle 40, 41 which is ready to cut in an opportunity to cut in onto the traffic lane 3 of the vehicle group 1. For this purpose, on the basis of the predicted trajectory T of the vehicle 40, 41 which is ready to cut in, a vehicle 2i of the vehicle group 1 is selected, for which the ingress distance dE is specified as the setpoint distance dSollj and which then becomes a guide vehicle X.k, k>1 of a following partial vehicle group 1.k, k>1.

The selection of the guide vehicle X.k, k>1 may be performed such that the vehicle 40, 41 which is ready to cut in needs to change its present driving dynamics, that is to say its cut-in speed v2, as little as possible. This may be performed for example by ascertainment of a point of convergence Z of the trajectory T with the vehicle group 1. If the respectively defined guide vehicle X.k, k>1 correspondingly sets the ingress distance dE by means of its adaptive cruise control system 5, the vehicle 40, 41 which is ready to cut in can readily move onto the traffic lane 3 of the vehicle group 1 into the intermediate space R thus formed. All other vehicles 2i of this following partial vehicle group 1.k, k>1 then follow the changed movement of the guide vehicle X.k, k>1 of the respective following partial vehicle group 1.k, k>1, such that the movement of the vehicle group 1 as a whole remains intercoordinated.

The length of the ingress distance dE or of the intermediate space R may be defined differently after a fulfilled ingress criterion K has been determined:

In the simplest case, the ingress distance dE may be defined as being a value such that vehicles 40, 41 which are ready to cut in, preferably passenger motor vehicles, with vehicle lengths L of usually up to 6 meters, can at least briefly cut in and are not put in danger in so doing. A maximum length LMax of 6 meters is thus assumed for the vehicle 40, 41 which is ready to cut in. As a result, the outlay on closed-loop control and the object identification algorithm can be simplified, because an exact determination of the vehicle length L from the surroundings data UD is not necessary.

On the basis of this maximum length LMax of 6 meters, a minimum distance dmin of between 10 m and 25 m is also taken into consideration, which must be maintained in any case between the vehicle 40, 41 which is ready to cut in and which has the assumed maximum length LMax and the partial vehicle group 1.k respectively driving in front of and behind said vehicle. The ingress distance dE may accordingly be defined for example as being a value between approximately 25 m and 60 m, in particular as being 35 m. Here, it must be taken into consideration that cutting-in vehicles 40, 41 normally remain on the traffic lane 3 of the vehicle group 1 between the partial vehicle groups 1.k only briefly, and will change lanes a short time later in order to overtake the vehicle group 1 or fall behind the vehicle group 1.

According to a further embodiment, however, it may also be provided that the ingress distance dE is determined in a manner dependent on the vehicle length L, derived from the surroundings data UD, of the vehicle 40, 41 identified as being ready to cut in. The ingress distance dE is thus defined such that the following applies: dSollj=dE≥L+2×dmin, with the abovementioned parameters for the minimum distance dmin.

Furthermore, in the definition of the ingress distance dE as the setpoint distance dSollj, it is taken into consideration that the vehicles 2i of the vehicle group 1 as a whole can continue to communicate via the wireless V2X communication 9. The partial vehicle groups 1.k are accordingly not separated from one another to too great an extent, in order to continue to ensure intercoordinated and efficient driving operation over the vehicle group 1 as a whole. At the same time, however, it is made possible for a vehicle 40, 41 identified as being ready to cut in to safely and reliably cut in without disrupting the driving operation of the vehicle group 1.

In order to check the ingress criterion K, in addition or as an alternative to the ascertainment of the predicted trajectory T of the respective vehicle 40, 41 in the surroundings U, it may be checked on the basis of the available surroundings data UD whether the vehicle 40, 41 is in any way indicating, by way of a cut-in indication H, that it wishes to move onto the traffic lane 3 of the vehicle group 1. For this purpose, it is for example possible to check the activation of a turn signal B of the respective vehicle 40, 41 in the direction of the traffic lane 3 of the vehicle group 1 as a cut-in indication H. From the surroundings data UD, it is also possible to extract, as a cut-in indication H, whether the respective vehicle 40, 41 has activated a headlamp flasher LH.

If the trajectory T accordingly cannot be ascertained, or can be ascertained only incorrectly, or if an ascertainment of a trajectory T is not provided, it may for example be checked, by means of the cut-in indication H, whether a vehicle 40 on the entry ramp 31 or on the adjacent traffic lane 3a intends to move onto the traffic lane 3 of the vehicle group 1. In this way, an incorrectly made decision based on incorrectly ascertained trajectories T can be avoided, or an ingress criterion K ascertained using the trajectory T can be checked for plausibility.

Furthermore, in the context of the check as to whether the ingress criterion K is fulfilled, the presence of an entry ramp 31 or of the exit ramp 32, which can likewise be derived from the surroundings data UD, may also be decisive. It may thus be defined that a lane change for a vehicle 40, 41 which is ready to cut in is actually made possible only if the vehicle group 1 is highly likely to constitute an obstruction for the lane-changing vehicles 40, 41. This can prevent the vehicles 40, 41 from permanently sitting, in an unauthorized manner, between the partial vehicle groups 1.k.

Only when the vehicle 40, 41 has left the traffic lane 3 of the vehicle group 1 again, which is likewise detected by means of the surroundings detection systems 6i, 60 and ascertained by the lead vehicle Z from the surroundings data UD, are the two partial vehicle groups 1.k brought together again in a manner coordinated by the lead vehicle Z, by virtue of the group following spacing dF again being specified as the setpoint distance dSollj for the guide vehicle X.k, k>1 of the respective following partial vehicle group 1.k, k>1 and the vehicle group 1 continuing its journey as before. For this purpose, the guide vehicle X.k, k>1 of the respective following partial vehicle group 1.k, k>1 and all other vehicles 2i that follow behind are accelerated again in an intercoordinated manner by means of the adaptive cruise control systems 5 in order to continue the coordinated journey.

In principle, with the method described, it is also possible for the setpoint distance dSollj or the ingress distance dE for the guide vehicle X.k, k>1 of the respective following partial vehicle group 1.k, k>1 to be defined such that more than one vehicle 40, 41 can cut into the intermediate space R. This may be useful for example if two vehicles 40 entering directly one behind the other are in the driving situation according to FIG. 2a or two vehicles 41 which are ready to exit are in the driving situation according to FIG. 2b, for each of which vehicles the ingress criterion K is fulfilled. However, it is necessary to consider the number of vehicles 40, 41 which are ready to cut in for which it makes sense to form an intermediate space R without thus impeding the other traffic and/or losing the capability of coordinating the vehicle group 1.

Furthermore, the intermediate space R between the partial vehicle groups 1.k may also be available for other, short-term cutting-in maneuvers in which another vehicle intends to change lanes “through” the vehicle group 1. For all of the stated cutting-in maneuvers, it is the case here that the respective vehicle 40, 41 which is ready to cut in does not communicate with the vehicle group 1 in order to coordinate the lane change therewith. Thus, no request on the basis of which the vehicles 2i of the vehicle group 1 can or could react is issued by the respective vehicle 40, 41 which is ready to cut in.

If, in all of the abovementioned embodiments, one or more vehicles 40, 41 which are ready to cut in remain in the intermediate space R for a relatively long period of time, provision may be made for the setpoint distance dSollj to be increased further for the respective guide vehicle X.k proceeding from the ingress distance dE. In this way, permanently safe driving operation can be ensured even if a vehicle 40, 41 driving in the vehicle group 1 does not communicate with the latter via the V2X communication 9.

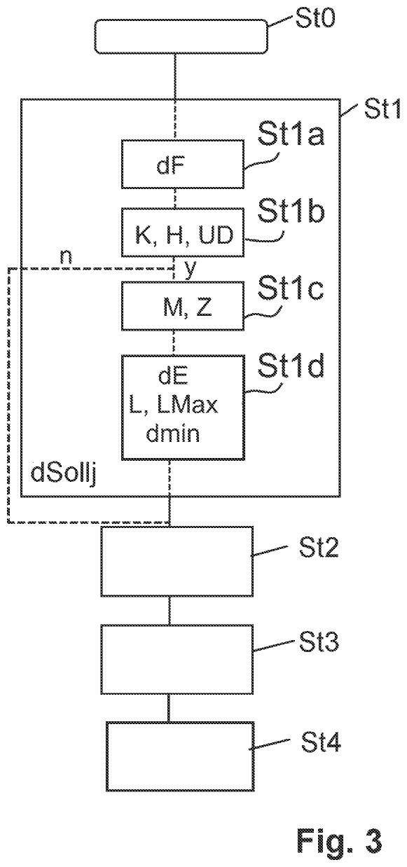

According to FIG. 3, the method according to the invention can be carried out for example as follows:

An initialization takes place in an initial step St0, for example with the set-up of the vehicle group 1. In a subsequent first step St1, the setpoint distances dSollj between the individual vehicles 2i of the vehicle group 1 are defined in a coordinated manner. Here, for each vehicle 2i of the vehicle group 1, first the group following distance dF is defined as the setpoint distance dSollj (St1a). Subsequently, in a manner dependent on the surroundings data UD, an ingress criterion K is checked which indicates whether an object or vehicle which is ready to cut in is situated in the surroundings. Cut-in indications H may additionally also be checked for this purpose (St1b).

If the ingress criterion K is not fulfilled, the group following distances dF are correspondingly set in steps St2 and St3. If the ingress criterion K is fulfilled, that is to say if a vehicle 40, 41 which is ready to cut in is identified, then the vehicle group 1 is divided into a number M of partial vehicle trains 1.k, such that a guide partial vehicle group 1.1 is followed by at least one following partial vehicle group 1.k, k>1, wherein, for this purpose, guide vehicles X.k, k>1 are defined for each following partial vehicle group 1.k, k>1 (St1c). This is performed for example in a manner dependent on the point of convergence Z, that is to say the vehicle 2.i, at which the predicted trajectory T of the vehicle 40, 41 which is ready to cut in converges on the vehicle group 1. If it follows from this that the point of convergence Z with the vehicle group 1 is situated so far toward the front or rear that the vehicle 40, 41 which is ready to cut in can also overtake the vehicle group 1 from the front or rear in a non-safety-critical manner, the division may also be canceled.

An ingress distance dE which is greater than the group following distance dF is subsequently specified as the setpoint distance dSollj for the defined guide vehicle X.k, k>1 of the respective following partial vehicle group 1.k, k>1 (St1d). The ingress distance dE is defined either in a manner dependent on a maximum length LMax of a conventional vehicle 40, 41 or is variably set in a manner dependent on the actual vehicle length L, ascertained from the surroundings data UD, of the vehicle 40, 41 which is ready to cut in, wherein a minimum distance dmin to the front and to the rear is taken into consideration in both cases. The defined setpoint distances dSollj are subsequently, in a second step St2, transmitted to the respective vehicles 2i in the vehicle group 1 via the V2X communication 9, and, in a third step St3, are implemented in the respective vehicle 2i by means of the adaptive cruise control system 5.

After the vehicle 40, 41 that has cut in has left the intermediate space R again, the partial vehicle groups 1.k can be brought together in a fourth step St4, wherein, for this purpose, the setpoint distance dSollj of the guide vehicle X.k, k>1 of the respective following partial vehicle group 1.k, k>1 is defined again as being the original group following distance dF. The division into several partial vehicle groups 1.k may be performed continuously, for example in order to be able to react accordingly at every entry ramp 31 or exit ramp 32.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE DESIGNATIONS (PART OF THE DESCRIPTION)

1 Vehicle group
1.k k-th partial vehicle group
1.1 Guide partial vehicle group
1.k, k>1 Following partial vehicle group
2i i-th vehicle in the vehicle group 1
3 Traffic lane of the vehicle group 1
3a Adjacent traffic lane
4 Multi-lane road
5 Adaptive cruise control system
6i Internal surroundings detection system in the i-th vehicle 2i
7 Brake system
8 Drive system
9 Wireless communication
10 V2X unit
30 Entry ramp region
31 Entry ramp
32 Exit ramp
40 Entering vehicle (vehicle ready to cut in)
41 Vehicle ready to exit (vehicle ready to cut in)
50 Infrastructure facility
60 External surroundings detection system, for example in the infrastructure facility 50
70 Evaluation unit
B Turn signal
dB Distance amount
dE Ingress distance
dF Group following distance
dIstj Actual distance in front of the i-th vehicle with j=i−1
dmin Minimum distance
dSollj Setpoint distance in front of the i-th vehicle with j=i−1
E Ingress conditions
H Cut-in indication
i, j, k Index
K Ingress criterion
L Vehicle length
LMax Maximum length
LH Headlamp flasher
M Number of partial vehicle groups 1.k
N Number of vehicles 2i
NMax Maximum number of vehicles 2i in a partial vehicle group
R Intermediate space
T Trajectory
U Surroundings
UD Surroundings data
v1 Group speed
v2 Cut-in speed
Z Point of convergence
X.k Guide vehicle of the k-th partial vehicle group
Z Lead vehicle
St1, St1a, St1b, St1c, St1d, StT, St2, St3, St3 Steps of the method

1. A method for coordinating a vehicle group comprising a number of vehicles, the vehicles of the vehicle group moving with specified setpoint distances to one another on a traffic lane and communicating wirelessly with one another via V2X communication, the specified setpoint distance being set by the respective vehicle by an adaptive cruise control system, the setpoint distances being defined such that the vehicle group is at least temporarily divided into a number of at least two partial vehicle groups, an ingress distance being at least temporarily set between the partial vehicle groups such that, between the respective partial vehicle groups, an intermediate space forms into which at least one vehicle which is ready to cut in and which has a vehicle length can move, and a group following distance which is smaller than the ingress distance being set between the vehicles within a partial vehicle group, the method comprising:
hecking an ingress criterion in a manner dependent on surroundings data, the ingress criterion indicating whether, in surroundings around the vehicle group, there is situated at least one vehicle which is ready to cut in and which intends to move into a traffic lane of the vehicle group in the region of the vehicle group,
wherein, if the ingress criterion is fulfilled, the vehicle group is divided into at least two partial vehicle groups by the ingress distance being specified as the setpoint distance for at least one vehicle of the vehicle group, which is preceded by a vehicle of the same vehicle group, to form the intermediate space.

2. The method of claim 1, wherein the surroundings data characterize the surroundings around the vehicle group.

3. The method of claim 2, wherein the surroundings data are output by at least one surroundings detection system,
wherein the at least one surroundings detection system monitors surroundings around the vehicle group,
wherein the surroundings data are transmitted via the V2X communication between the vehicles of the vehicle group and/or between the vehicles and an infrastructure facility outside the vehicle group, which infrastructure facility has an external surroundings detection system.

4. The method of claim 2, wherein the surroundings data from different surroundings detection systems are merged.

5. The method of claim 1, wherein, as ingress criterion, the method comprises checking whether a predicted trajectory, which results from the surroundings data, of a vehicle situated in the surroundings has a point of convergence with the vehicle group, in order to determine whether, in the surroundings, there is situated a vehicle which is ready to cut in and which intends to move into the traffic lane of the vehicle group in a region of the vehicle group.

6. The method of claim 5, wherein the vehicle of the vehicle group for which the ingress distance is specified as the setpoint distance is selected in a manner dependent on the point of convergence such that the vehicle which is ready to cut in and which is following the predicted trajectory is configured to approximately maintain its cut-in speed when cutting into the intermediate space.

7. The method of claim 1, wherein checking the ingress criterion includes considering cut-in indications, and
wherein the cut-in indications comprise activation of a turn signal and/or of a headlamp flasher of a vehicle in the surroundings, which indicate whether the vehicle in the surroundings in a region of the vehicle group wishes to move onto the traffic lane of the vehicle group.

8. The method of claim 1, wherein the ingress criterion is checked, and/or the ingress distance is specified as the setpoint distance for the respective vehicle if the ingress criterion is fulfilled, only if the vehicle group is approaching an entry ramp and/or an exit ramp, such that the division into at least two partial vehicle groups takes place only if the vehicle group is approaching an entry ramp and/or an exit ramp.

9. The method of claim 8, wherein a presence of an entry ramp and/or an exit ramp results from the surroundings data.

10. The method of claim 1, wherein, when dividing the vehicle group into at least two partial vehicle groups by specification and setting the ingress distance as the setpoint distance in the vehicle, no communication is performed via the V2X communication with a vehicle which is ready to cut in.

11. The method of claim 1, wherein, if the ingress criterion is fulfilled, a vehicle of the vehicle group is selected as a guide vehicle of a following partial vehicle group, and
wherein the ingress distance is specified as the setpoint distance for the guide vehicle of the respective following partial vehicle group, such that a guide partial vehicle group is followed, at the ingress distance, by at least one following partial vehicle group led by the guide vehicle.

12. The method of claim 1, wherein the ingress distance is defined such that, after setting the ingress distance as the setpoint distance, an intermediate space forms between the partial vehicle groups thus formed, such that a vehicle which is ready to cut in and which has a vehicle length not exceeding a predefined maximum length is movable onto the traffic lane of the vehicle group into the intermediate space between the at least two partial vehicle groups.

13. The method of claim 12, wherein the maximum length is between 5 m and 10 m.

14. The method of claim 1, wherein the ingress distance is defined in a manner dependent on the vehicle length of the vehicle which is ready to cut in, and
wherein the vehicle length is derived from the surroundings data.

15. The method of claim 1, wherein the ingress distance is defined in a manner dependent on a minimum distance maintained in front of and behind the vehicle which is ready to cut in and which has the vehicle length or the maximum length, and
wherein the minimum distance is between 10 m and 25 m.

16. The method of claim 1, wherein the ingress distance is defined such that, after setting the ingress distance, vehicles of different partial vehicle groups are configured to continue to indirectly or directly communicate wirelessly with one another via the V2X communication to continuously coordinate the vehicle group as a whole.

17. The method of claim 1, wherein, if the ingress criterion is not fulfilled, the group following distance is set between all vehicles of the vehicle group,
wherein the group following distance is set dependent on driving dynamics characteristics of the vehicles of the vehicle group, and
wherein the group following distance is less than 25 meters.

18. The method of claim 1, wherein, after detecting that the vehicle which is ready to cut in has moved away again from the intermediate space, the group following distance is set between all vehicles.

19. The method of claim 1, wherein the vehicle which is ready to cut in is an entering vehicle, which intends to move from an entry ramp onto the traffic lane of the vehicle group, or is a vehicle which is ready to exit, which intends to move from an adjacent traffic lane via the traffic lane of the vehicle group onto an exit ramp.

20. An evaluation unit for carrying out the method of claim 1, the evaluation unit being configured to:
define the setpoint distances between vehicles of a vehicle group such that the vehicle group at least is temporarily divided into a number of at least two partial vehicle groups;
wherein, for this purpose, at least temporarily set an ingress distance between the partial vehicle groups such that, between the respective partial vehicle groups, an intermediate space forms into which at least one vehicle which is ready to cut in and which has a vehicle length is movable;
and can set a group following distance, which is smaller than the ingress distance, between the vehicles within a partial vehicle group; and
the evaluation unit (70) can furthermore check an ingress criterion in a manner dependent on surroundings data, the ingress criterion indicating whether, in surroundings around the vehicle group, there is situated at least one vehicle which is ready to cut in and which intends to move into a traffic lane of the vehicle group in the region of the vehicle group,
wherein, if the ingress criterion is fulfilled, the vehicle group is divisible into at least two partial vehicle groups by the ingress distance being specifiable as the setpoint distance for at least one vehicle of the vehicle group, which is preceded by a vehicle of the same vehicle group, to form the intermediate space.

21. A lead vehicle of a vehicle group, comprising:
an the evaluation unit of claim 20.

22. A vehicle group, comprising;
(1) a plurality vehicles,
wherein at least one vehicle of the plurality of vehicles, as lead vehicle, comprises the evaluation unit of claim 20, the lead vehicle being configured to communicate wirelessly with the vehicles of the vehicle group via V2X communication,
wherein the each vehicle of the plurality of vehicles has an adaptive cruise control system, and
system is in each case configured to set the setpoint distance, which is specified by the lead vehicle by the evaluation unit and which is transmitted via the V2X communication, to at least temporarily divide the vehicle group into at least two partial vehicle groups.

23. The method of claim 13, wherein the maximum length is 6 m.

24. The method of claim 17, wherein the group following distance is less than 15 meters.
